(19) United States
(12) Patent Application Publication
(10) Pub. No.: US 2020/0387090 A1
(43) Pub. Date: Dec. 10, 2020

(54) IMAGE FORMING APPARATUS AND CONTROL METHOD THEREOF

(71) Applicant: Konica Minolta Inc., Tokyo (JP)

(72) Inventor: NORITOSHI HAGIMOTO, Aichi (JP)

(21) Appl. No.: 16/880,851

(22) Filed: May 21, 2020

(30) Foreign Application Priority Data
Jun. 5, 2019 (JP) 2019-105315

(51) Int. Cl. G03G 15/16; G03G 21/10

(52) U.S. Cl. CPC G03G 15/161; G03G 21/10

(57) ABSTRACT

An image forming apparatus includes: a plurality of imaging units; an intermediate transfer belt; a belt cleaner; and a controller, wherein the controller determines a degree of deterioration based on a residence time within the imaging units, for each of toners of the respective colors, determines a discharge amount of each of the toners of the respective colors on a basis of the degree of deterioration, controls the plurality of imaging units in accordance with a ratio of the discharge amount of each of the toners of the respective colors, and causes a waste toner pattern in which the toners of the respective colors are continuously arranged to be formed a plurality of times, while providing a predetermined interval, on the intermediate transfer belt, and the belt cleaner cleans the waste toner pattern transferred the plurality of times to the intermediate transfer belt.

The entire disclosure of Japanese patent Application No. 2019-105315, filed on Jun. 5, 2019, is incorporated herein by reference in its entirety.

### BACKGROUND

### Technological Field

The present disclosure relates to an image forming apparatus, and more specifically, to toner discard control.

### Description of the Related art

In recent years, image forming apparatuses can use a wide variety of media. For example, as the media, an embossed sheet having an uneven surface, a special sheet subjected to a surface treatment, and the like may be used. When the image forming apparatuses perform printing processing using these media, a highly accurate transfer technique is required as compared with printing processing using an ordinary sheet.

To provide a high quality printing function for the wide variety of media described above, many image forming apparatuses are provided with settings and functions suitable for the various media. An image forming apparatus has a function for a special medium, for example, a function of changing a setting of a transfer current or a voltage and a function of changing a pressing force of a transfer unit. However, when the toner in the image forming apparatus has deteriorated, there has been a case where the image forming apparatus is not able to provide sufficient print quality even by using these individual functions. For that reason, the image forming apparatus has needed to regularly discard the toner in the image forming apparatus and refresh the toner to suppress the deterioration of the toner.

For example, regarding toner discard control, JP 2016-114710 A discloses an image forming apparatus in which “When a predetermined condition for executing a forced consumption mode is satisfied, a discharge execution flag is set. Next, if a predetermined timing for executing the forced consumption mode is not reached, image formation is continued without executing the forced consumption mode. Then, when the predetermined condition is not satisfied between the time when the discharge execution flag is set and the predetermined timing when the forced consumption mode is executed, the discharge execution flag is cleared. As a result, the forced consumption mode is not executed at the predetermined timing, and the amount of consumption of the toner is suppressed.” (See [Abstract of the Disclosure]). In addition, other techniques related to the toner discard control are disclosed in JP 2006-023327 A, JP 2014-222298 A, JP 2012-189663 A, and JP 2015-125193 A.

According to the techniques disclosed in JP 2016-114710 A, JP 2006-023327 A, JP 2014-222298 A, JP 2012-189663 A, and JP 2015-125193 A, it is not possible to discard the toner while suppressing occurrence of a cleaning failure. Thus, a technique is required for discarding the toner while suppressing the occurrence of the cleaning failure.

### SUMMARY

The present disclosure has been made in view of the above background, and an object in one aspect is to provide a technique for discarding the toner while suppressing the occurrence of the cleaning failure.

To achieve the abovementioned object, according to an aspect of the present invention, an image forming apparatus reflecting one aspect of the present invention comprises: a plurality of imaging units that forms toner images of respective colors; an intermediate transfer belt that transfers the toner images; a belt cleaner that cleans the intermediate transfer belt; and a controller that controls the image forming apparatus, wherein the controller determines a degree of deterioration based on a residence time within the imaging units, for each of toners of the respective colors, determines a discharge amount of each of the toners of the respective colors on a basis of the degree of deterioration, controls the plurality of imaging units in accordance with a ratio of the discharge amount of each of the toners of the respective colors, and causes a waste toner pattern in which the toners of the respective colors are continuously arranged to be formed a plurality of times, while providing a predetermined interval, on the intermediate transfer belt, and the belt cleaner cleans the waste toner pattern transferred the plurality of times to the intermediate transfer belt.

### BRIEF DESCRIPTION OF THE DRAWINGS

The above and other objects, aspects, advantages, and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration example of an image forming apparatus according to an embodiment;

FIG. 2 is a diagram illustrating an example of a configuration around an intermediate transfer belt;

FIG. 3 is a diagram illustrating an example of a circuit configuration of a part of the image forming apparatus;

FIG. 4 is a diagram illustrating an example of a basic setting table;

FIG. 5 is a diagram illustrating an example of a discharge amount table;

FIG. 6 is a diagram illustrating an example of a discharge pattern setting table;

FIG. 7 is a diagram illustrating a first example of a waste toner pattern;

FIG. 8 is a diagram illustrating a second example of the waste toner pattern;

FIG. 9 is a diagram illustrating a third example of the waste toner pattern;

FIG. 10 is a diagram illustrating a fourth example of the waste toner pattern;

FIG. 11 is a diagram illustrating a fifth example of the waste toner pattern;

FIG. 12 is a diagram illustrating an example of a state of separation of the waste toner pattern in the fifth example of the waste toner pattern;

FIG. 13 is a diagram illustrating an example of a comparison between a waste toner removing method according to the embodiment and a conventional waste toner removing method;

FIG. 14 is a diagram illustrating an example of a flow of toner discard processing; and

FIG. 15 is a diagram illustrating an example of a flow of toner discard processing by manual operation.

### DETAILED DESCRIPTION OF EMBODIMENTS

Hereinafter, one or more embodiments of a technical idea according to the present invention will be described with reference to the drawings. However, the scope of the invention is not limited to the disclosed embodiments. In the following description, the same components are denoted by the same reference numerals. The names and functions thereof are also the same. Thus, detailed description thereof will not be repeated.

First, a configuration will be described of an image forming apparatus 100 according to the present embodiment. The image forming apparatus 100 is a color image forming apparatus, for example, a Multifunction Peripheral (MFP), or the like, but an application target of the technical idea according to the present embodiment is not limited to the color image forming apparatus. The technical idea can be applied to a monochrome image forming apparatus.

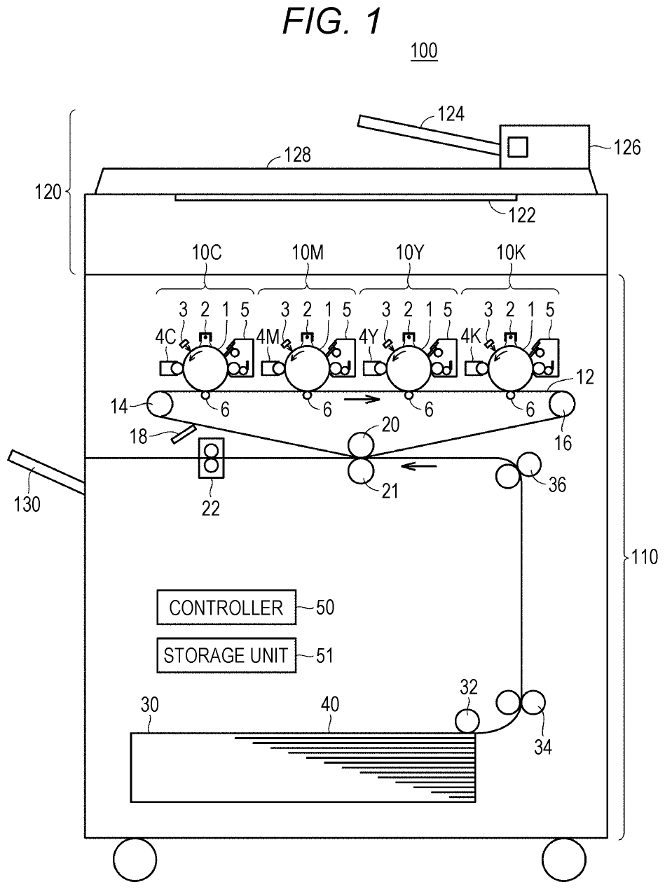

FIG. 1 is a diagram illustrating a configuration example of the image forming apparatus 100 according to the present embodiment. The image forming apparatus 100 includes a print engine 110, a document reading unit 120, and an ejection tray 130.

The print engine 110 includes imaging units 10C, 10M, 10Y, and 10K that generate respective toner images of cyan (C), magenta (M), yellow (Y), and key plate (K) (hereinafter may be collectively referred to as “imaging units 10”), an intermediate transfer belt 12, intermediate transfer member drive rollers 14 and 16, a belt cleaner 18, transfer rollers 20 and 21, a fixing unit 22, a sheet feeding unit 30, a feeding roller 32, conveying rollers 34 and 36, a controller 50, and a storage unit 51. The imaging units 10 each include a photoreceptor 1, a charger 2, an exposing unit 3, and a developer 4 (described as 4C, 4M, 4Y, and 4K respectively corresponding to the colors of the toner images generated by the corresponding imaging units 10), a cleaner 5, and an intermediate transfer member contact roller 6. The document reading unit 120 includes an image scanner 122, a document feeding table 124, an automatic document feeder 126, and a document ejection table 128.

The print engine 110 performs printing processing on a medium 40 in the sheet feeding unit 30. The feeding roller 32 conveys the medium 40 from the sheet feeding unit 30. The conveying rollers 34 and 36 convey the medium 40 toward the transfer rollers 20 and 21. The transfer rollers 20 and 21 transfer a toner image to the medium 40. After that, the fixing unit 22 performs fixing processing on the medium 40. Finally, the medium 40 is ejected to the ejection tray 130.

The imaging units 10 and the intermediate transfer belt 12 generate toner images to be transferred to the medium 40. The charger 2 uniformly charges the surface of the photoreceptor 1 that is an image carrier. The exposing unit 3 forms an electrostatic latent image on the surface of the photoreceptor 1 by exposing the surface of the photoreceptor 1 in accordance with an image pattern specified by laser writing or the like. The developer 4 develops the electrostatic latent image formed on the photoreceptor 1 as a toner image.

The intermediate transfer member contact roller 6 transfers the toner image formed on the surface of the photoreceptor 1 to the intermediate transfer belt 12. The toner images are sequentially transferred from the respective photoreceptors 1 onto the intermediate transfer belt 12, and the toner images of four colors are superimposed on the intermediate transfer belt 12. The transfer rollers 20 and 21 transfer the superimposed toner images from the intermediate transfer belt 12 to the medium 40.

After the transfer of the toner image from the photoreceptor 1 to the intermediate transfer belt 12, the cleaner 5 removes toner and an external additive remaining on the surface of the photoreceptor 1 to clean the photoreceptor 1. The cleaner 5 removes the toner and the external additive on the surface of the photoreceptor 1 by a stationary layer formed by toner staying between the cleaner 5 and the photoreceptor 1. The stationary layer has a role of not only cleaning the surface of the photoreceptor 1 but also reducing friction between the cleaner 5 and the photoreceptor 1 to protect the cleaner 5 and the photoreceptor 1.

After the toner image is transferred from the intermediate transfer belt 12 to the medium 40, the belt cleaner 18 removes the toner and the external additive remaining on the surface of the intermediate transfer belt 12. The belt cleaner 18 removes the toner and the external additive on the surface of the intermediate transfer belt 12 by a stationary layer formed by toner staying between the belt cleaner 18 and the intermediate transfer belt 12. The image forming apparatus 100 according to the present embodiment also cleans waste toner discharged from each of the imaging units 10 and transferred to the intermediate transfer belt 12 by using the belt cleaner 18.

The document reading unit 120 reads a document and outputs the read result as an input image to the print engine 110. The image scanner 122 scans a document placed on a platen glass. The automatic document feeder 126 continuously feeds documents placed on the document feeding table 124. A feeding roller (not illustrated) included in the document feeding table 124 feeds out the documents placed on the document feeding table 124 one by one. The image scanner 122 and an image sensor arranged in the automatic document feeder 126 sequentially scan the documents. The scanned documents are ejected to the document ejection table 128.

The controller 50 controls the entire image forming apparatus 100. The storage unit 51 stores firmware and various settings of the image forming apparatus 100. The controller 50 refers to necessary data and programs from the storage unit 51.

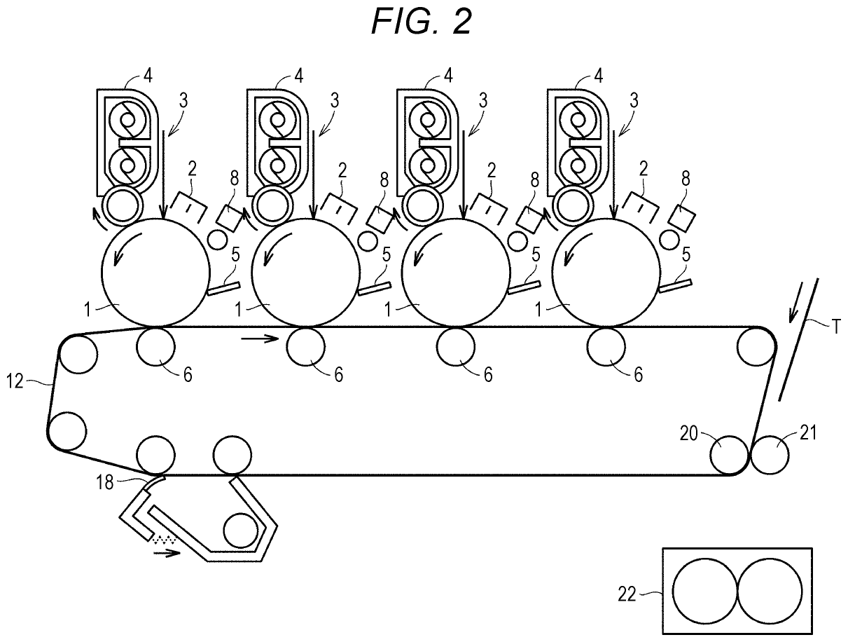

FIG. 2 is a diagram illustrating an example of a configuration around the intermediate transfer belt 12. With reference to FIG. 2, a description will be given of a degree of deterioration of toner and a flow of toner discard processing. The imaging units 10 can each include a lubricant supply unit 8 that supplies a lubricant to the photoreceptor 1 in addition to the configuration of FIG. 1.

First, the degree of deterioration of the toner will be described. The toner of each color stays in each developer 4. The developer 4 supplies the toner to the photoreceptor 1 at the time of printing processing. When the toner in the developer 4 decreases, a toner supply unit (not illustrated) in the image forming apparatus 100 replenishes the developer 4 with new toner. In one aspect, the new toner may be supplied to the developer 4 from outside the image forming apparatus 100.

The toner deteriorates as the residence time in the developer 4 increases. In addition, since the toner is supplied to the developer 4 as needed, the degree of deterioration of the toner in the developer 4 is not uniform. Thus, the image forming apparatus 100 according to the present embodiment treats an average value of the residence time of the toner in the developer 4 as the degree of deterioration of the toner. For example, when “50%” of the toner in the developer 4Y stays in the developer 4Y for “20 hours” and “50%” of the toner is newly added to the developer 4Y, the average residence time of the toner in the developer 4Y is “10 hours”. The image forming apparatus 100 uses the average residence time as an index of the degree of deterioration of the toner.

Next, the toner discard processing will be described. The toner staying in the developer 4 for a long time may cause degradation of transfer performance during printing. For that reason, the image forming apparatus 100 discards the toner having a low frequency of use and a long residence time, that is, so-called the toner having a high degree of deterioration, thereby suppressing the average degree of deterioration of the toner and maintaining the transfer performance of the toner. The waste toner is transferred from the developer 4 to the photoreceptor 1 and further transferred to the intermediate transfer belt 12. The belt cleaner 18 removes the waste toner transferred to the intermediate transfer belt 12.

The amount of the waste toner removed by the belt cleaner 18 may be larger than the amount of residual toner during normal printing. For that reason, the waste toner may pass through between the belt cleaner 18 and the intermediate transfer belt 12, and may cause cleaning failure.

To solve the above-described problem, the image forming apparatus 100 according to the present embodiment can determine the amount of the waste toner to be discharged from the developer 4 depending on the amount of consumption or the degree of deterioration of the toner of each color, and transfer the waste toner to the intermediate transfer belt 12 so that the toners of the respective colors do not overlap each other. Note that, the waste toner may be transferred to the intermediate transfer belt 12 as a solid image or a toner patch. Hereinafter, the waste toner transferred to the intermediate transfer belt 12 is referred to as a “waste toner pattern”.

The length of the waste toner pattern in the traveling direction of the intermediate transfer belt 12 is kept within a predetermined length. The predetermined length can be set, for example, to a length that does not cause the cleaning failure when the belt cleaner 18 removes the waste toner pattern from the intermediate transfer belt 12. The predetermined length may be obtained by an experiment.

In addition, when the amount of the waste toner is large, the image forming apparatus 100 can form the waste toner pattern a plurality of times while providing a predetermined interval on the intermediate transfer belt 12. The predetermined interval is provided between the waste toner patterns, whereby the amount of waste toner to be removed by the belt cleaner 18 is reduced, and occurrence of the cleaning failure can be suppressed.

Note that, it is desirable that the toners of the respective colors included in the waste toner pattern do not overlap each other like a striped pattern to reduce the amount of the toner reaching the belt cleaner 18; however, examples of formation of the waste toner pattern are not limited to this. In one aspect, the toners of the respective colors included in the waste toner pattern may be transferred to the intermediate transfer belt 12 in a state of partially overlapping each other.

As described above, in the image forming apparatus 100 according to the present embodiment, the waste toner pattern is discharged depending on the ratio of the amount of consumption of the toner of each color. In addition, a certain interval is provided between the waste toner patterns. For that reason, the belt cleaner 18 does not need to remove a large amount of the waste toner at a time, and as a result, the cleaning failure in the belt cleaner 18 is suppressed.

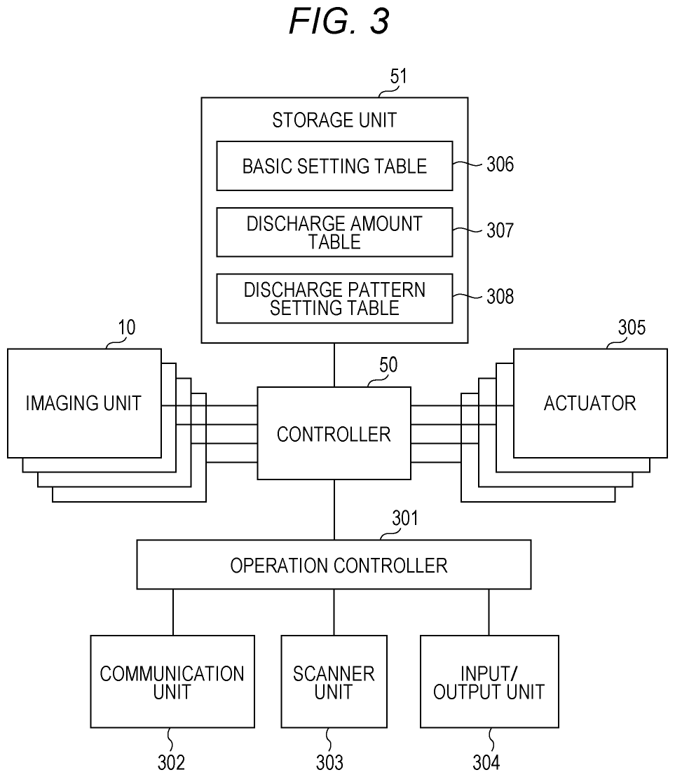

FIG. 3 is a diagram illustrating an example of a circuit configuration of a part of the image forming apparatus 100. The controller 50 is connected to the storage unit 51, the imaging units 10, a plurality of actuators 305, and an operation controller 301. The operation controller 301 is connected to a communication unit 302, a scanner unit 303, and an input/output unit 304.

The communication unit 302 receives an image or a print job from a terminal such as an external computer, and transmits data to the terminal. In addition, the communication unit 302 may receive a toner refresh (discard) command from an external terminal. The scanner unit 303 acquires image data from the document reading unit 120. The input/output unit 304 accepts an input from a touch panel or a button (not illustrated) provided on a housing of the image forming apparatus 100, and displays information on a monitor (not illustrated) provided on the housing of the image forming apparatus 100. In addition, the input/output unit 304 may accept an input of the toner refresh (discard) command from an external terminal

The operation controller 301 transmits a print instruction to the controller 50 on the basis of the image data or the print job received from any of the communication unit 302, the scanner unit 303, and the input/output unit 304. In addition, the operation controller 301 transmits a dot count, the image data, and the like to the controller 50. Further, the operation controller 301 may receive the toner refresh (discard) command via the communication unit 302 or the input/output unit 304, and transmit the command to the controller 50.

The controller 50 prints the image data and discards the toner by controlling each actuator 305 on the basis of the reception of the print instruction from the operation controller 301. The controller 50 may acquire necessary data and programs from the storage unit 51 or a memory built in the controller 50.

Each actuator 305 may be an arbitrary actuator, for example, a motor for driving each of the imaging units 10 and various rollers, a halogen heater of the fixing unit 22, the charger 2, the exposing unit 3, the developer 4, or the like. A basic setting table 306 includes basic settings for the waste toner. A discharge amount table 307 includes the discharge amount of the toner of each color when the toner is discarded. A discharge pattern setting table 308 includes a discharge ratio of the waste toner pattern of one time of the toner of each color, and the like.

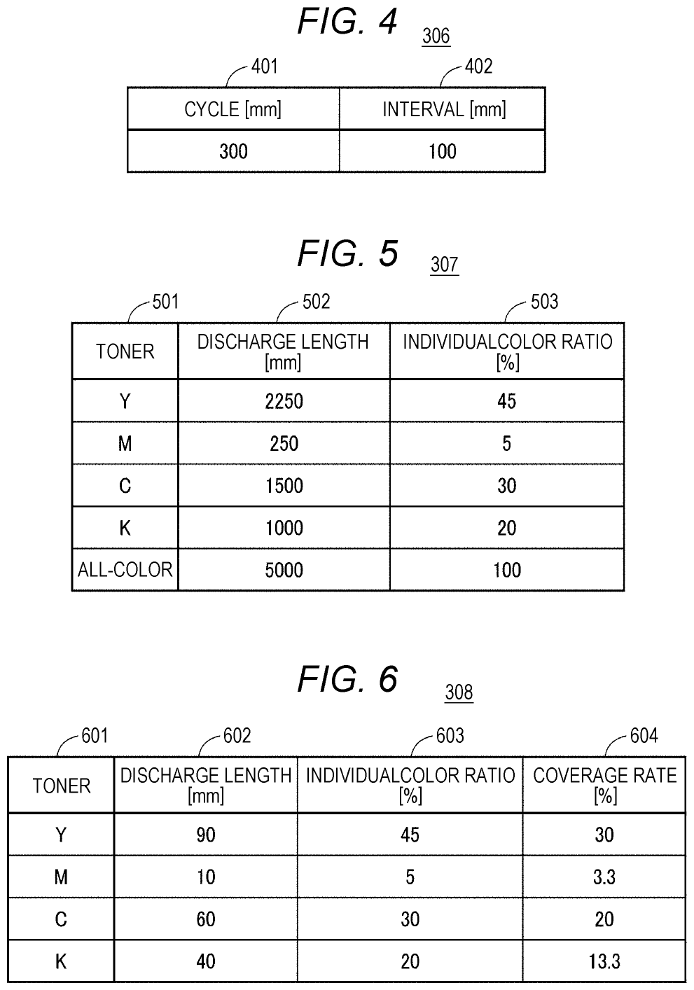

FIG. 4 is a diagram illustrating an example of the basic setting table 306. The basic setting table 306 includes a cycle 401 and an interval 402. The cycle 401 is the sum of the length of the waste toner pattern in the traveling direction of the intermediate transfer belt 12 and the length of the interval 402.

The interval 402 is an interval between the waste toner patterns on the intermediate transfer belt 12. In the case of an example illustrated in FIG. 4, when discarding the toner, the image forming apparatus 100 forms a waste toner pattern of a length of 200 mm a plurality of times while providing an interval of 100 mm in the traveling direction of the intermediate transfer belt 12, on the intermediate transfer belt 12. As a result, the length of one cycle is a total of 300 mm including the length of the waste toner pattern and the interval between the waste toner patterns.

Note that, the cycle 401 and the interval 402 are not limited to the example illustrated in FIG. 4, and can be appropriately set. In addition, the cycle 401 and the interval 402 may change depending on the operation time of the image forming apparatus 100. In that case, the controller 50 can set optimal values of the cycle 401 and the interval 402 depending on a deterioration state of the belt cleaner 18.

FIG. 5 is a diagram illustrating an example of the discharge amount table 307. The discharge amount table 307 includes a toner 501, a discharge length 502, and an individual color ratio 503. The toner 501 indicates toner colors yellow (Y), magenta (M), cyan (C), and black (K). All-color includes all of Y, M, C, and K.

The discharge length 502 is a total discharge length of the toner of each color in the traveling direction of the intermediate transfer belt 12 when the waste toner pattern is formed. For example, the toner of yellow (Y) has the discharge length 502 of “2250 mm”, which means that a waste toner patch of yellow (Y) for “2250 mm” is formed on the intermediate transfer belt 12. The discharge length 502 “5000 mm” of the toner of the all-color is the sum of discharge lengths of the toners of the respective colors. The individual color ratio 503 is a ratio of the discharge amount of the toner of each color within the discharge length 502 “5000 mm” of the toner of the all-color.

FIG. 6 is a diagram illustrating an example of the discharge pattern setting table 308. The discharge pattern setting table 308 is a setting when the waste toner pattern for one time is formed, and the setting can be generated from the basic setting table 306 and the discharge amount table 307.

The discharge pattern setting table 308 includes a toner 601, a discharge length 602, an individual color ratio 603, and a coverage rate 604. The toner 601 indicates toner colors yellow (Y), magenta (M), cyan (C), and black (K).

The discharge length 602 is a discharge length of the toner of each color included in the waste toner pattern of one time. The sum of discharge lengths of the toners of the respective colors included in the discharge length 602 is “200 mm” obtained by subtracting the value of the interval 402 from the value of the cycle 401. The individual color ratio 603 represents a content ratio of the toner of each color included in the waste toner pattern of one time. For example, since the toner 501 “Y” has the individual color ratio 603 of “45%”, “45%” of the toner included in the waste toner pattern is the toner of yellow (Y).

The coverage rate 604 indicates a coverage rate (also referred to as printing coverage) of the toner of each color with respect to the waste toner pattern. Since the coverage rate 604 depends on the density and area of the waste toner of each color transferred to the intermediate transfer belt 12, the coverage rate 604 is a value less than or equal to the individual color ratio 603. For example, since the toner 601 “Y” has the individual color ratio 603 of “45%”, the coverage rate 604 is less than or equal to “45%”.

The controller 50 stores the amount of consumption of the toner of each color in the storage unit 51 as needed for each image formation or toner discard. In one aspect, the controller 50 may record a remaining amount of the toner of each color as needed every time the image formation or the toner discard processing is performed, and may store the remaining amount of the toner of each color in the storage unit 51.

The controller 50 can determine the discharge length 602, the individual color ratio 603, and the coverage rate 604 depending on the amount of consumption of the toner of each color stored in the storage unit 51. For example, in the example illustrated in FIG. 4, the amount of consumption of the toner of magenta (M) is large, and the amount of consumption of the toner of yellow (Y) is small. For that reason, the controller 50 sets the ratio of the toner of magenta (M) included in the waste toner pattern low, and sets the ratio of the toner of yellow (Y) high. In addition, the controller 50 may adjust the discard amount of the toner by adjusting the coverage rate 604.

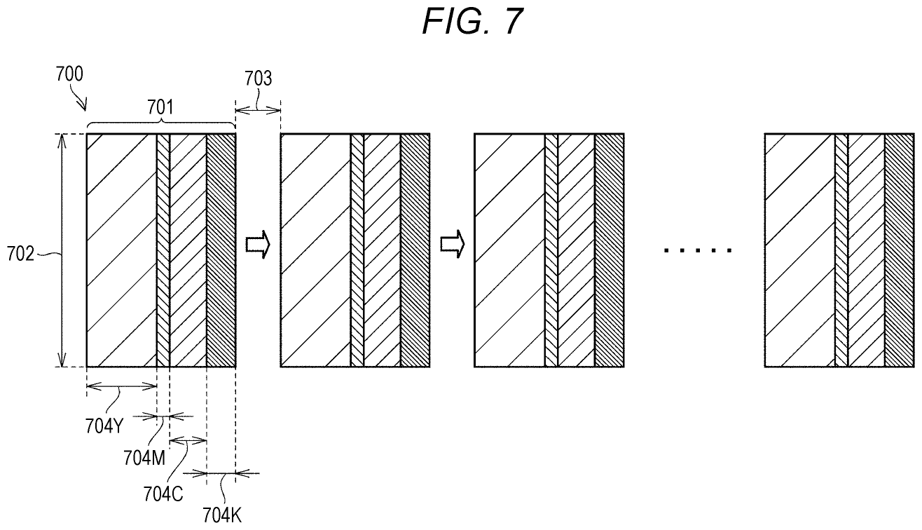

FIG. 7 is a diagram illustrating a first example of the waste toner pattern. A waste toner pattern 700 includes a waste toner 704Y of yellow (Y), a waste toner 704M of magenta (M), a waste toner 704C of cyan (C), and a waste toner 704K of black (K). The ratio of each of the waste toners 704Y, 704M, 704C, and 704K is based on the individual color ratio 603 in FIG. 5. Each of the waste toners 704Y, 704M, 704C, and 704K is, for example, a single-color solid image, and the solid images are adjacent to each other not to overlap each other. By doing so, the toner density of the waste toner pattern 700 is always uniform. In one aspect, the solid images may partially overlap each other.

A waste toner pattern length 701 is “200 mm” obtained by subtracting the value of the interval 402 from the value of the cycle 401, and a waste toner pattern width 702 is the length of the intermediate transfer belt 12 in the width direction. An interval 703 is “100 mm” defined for the interval 402.

As described above, the image forming apparatus 100 forms the waste toner pattern depending on the amount of the waste toner of each color, thereby reducing the total time for idle rotation of the photoreceptors 1 of all colors. Here, the idle rotation is a rotation of the photoreceptor 1 that does not involve a toner image. In addition, in the image forming apparatus 100, an appropriate interval is provided between the waste toner patterns, whereby the amount of the waste toner removed by the belt cleaner 18 at a time is reduced, and the occurrence of the cleaning failure is suppressed.

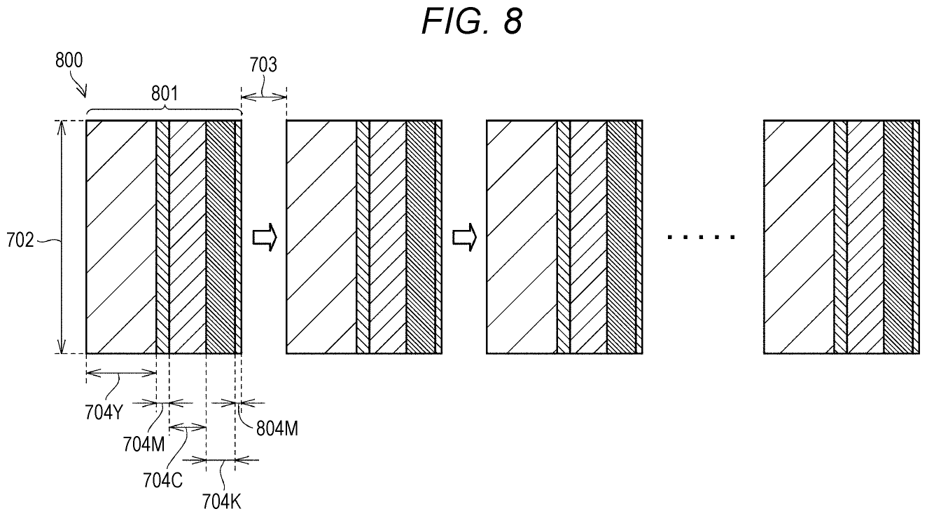

FIG. 8 is a diagram illustrating a second example of the waste toner pattern. The waste toner pattern 700 further includes a waste toner 804M of magenta (M) in addition to the waste toner 704Y of yellow (Y), the waste toner 704M of magenta (M), the waste toner 704C of cyan (C), and the waste toner 704K of black (K).

The controller 50 can adjust the amount of the toner of each color included in the waste toner pattern of one time, on the basis of a predetermined minimum coverage rate. For example, it is assumed that the predetermined minimum coverage rate is “5%”. In this case, according to the coverage rate 604 of FIG. 6, the coverage rate of magenta (M) is “3.3%”, which is insufficient by “1.7%” with respect to the minimum coverage rate of “5%”. For that reason, the controller 50 controls the imaging unit 10M so that the waste toner 804M of magenta (M) for the amount of the coverage rate “1.7%” is added to the tail or head of the waste toner pattern. In that case, a waste toner pattern length 801 is “200 mm+the length of the waste toner 804M”. Note that, the minimum coverage rate here is the minimum ratio that an area covered with the toner of each color should occupy, in the waste toner pattern.

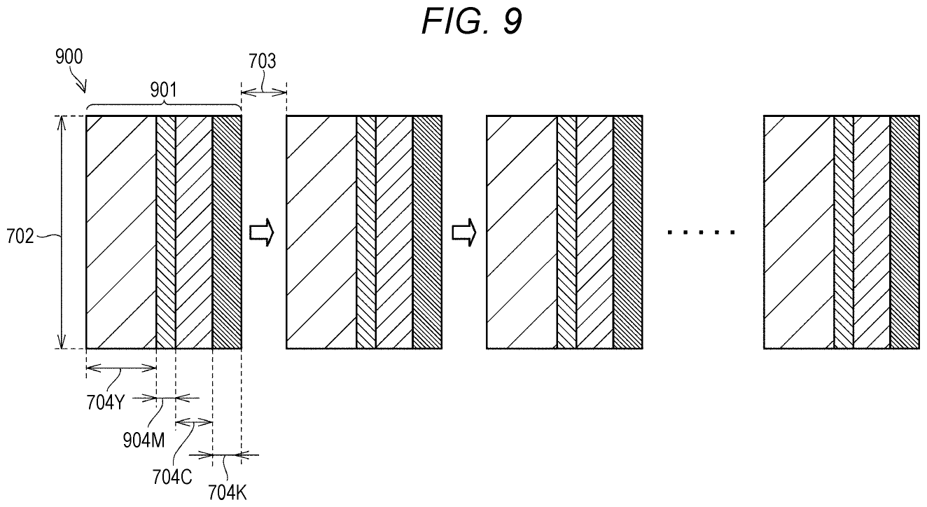

FIG. 9 is a diagram illustrating a third example of the waste toner pattern. A waste toner pattern 900 includes the waste toner 704Y of yellow (Y), a waste toner 904M of magenta (M), the waste toner 704C of cyan (C), and the waste toner 704K of black (K).

Also in the example of FIG. 9, the controller 50 can adjust the amount of the toner of each color included in the waste toner pattern of one time, on the basis of the predetermined minimum coverage rate. For example, it is assumed that the predetermined minimum coverage rate is “5%”. In this case, according to the coverage rate 604 of FIG. 6, the coverage rate of magenta (M) is “3.3%”, and the coverage rate is insufficient by “1.7%” with respect to the minimum coverage rate of “5%”.

Unlike the example of FIG. 8, the controller 50 includes the waste toner for the amount of the coverage rate “1.7%” in the waste toner 904M. That is, the waste toner 904M includes the waste toner 704M having the coverage rate “3.3%” and an additional waste toner for the amount of the coverage rate “1.7%”. As described above, the controller 50 may control the imaging units 10 to increase the discard amount of one time of the waste toner of a color whose coverage rate is less than the predetermined minimum coverage rate “5%”. In that case, a waste toner pattern length 901 is “200 mm+the length of the additional waste toner for the amount of the coverage rate “1.7%””.

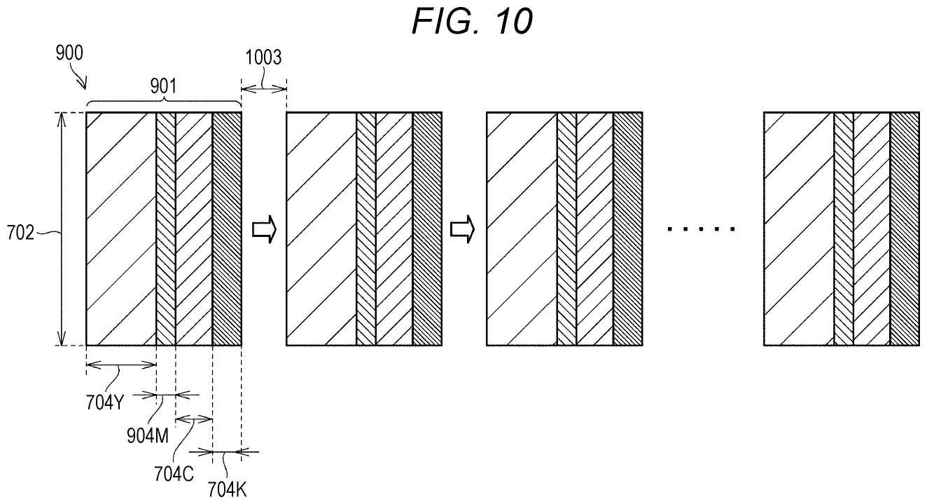

FIG. 10 is a diagram illustrating a fourth example of the waste toner pattern. In the example of FIG. 10, similarly to the example of FIG. 9, the controller 50 controls the imaging units 10 to increase the discard amount of one time of the waste toner of magenta (M).

Further, the controller 50 sets an interval 1003 to be shorter than “100 mm” defined for the interval 402 by the amount of the waste toner added on the basis of the minimum coverage rate. For example, in the present example, the controller 50 adds the additional waste toner of magenta (M) for the amount of the coverage rate “1.7%” to the waste toner pattern. At this time, in a case where the length of the waste toner of magenta (M) added is “5 mm”, the interval 1003 is “100−5=95 mm”. Note that, the control exemplified in FIG. 10 may be combined with any of the controls in FIGS. 8 and 9. As described above, the controller 50 shortens the interval between the waste toner patterns by the length of the waste toner added on the basis of the minimum coverage rate, thereby discarding the toner without extending the toner discard time.

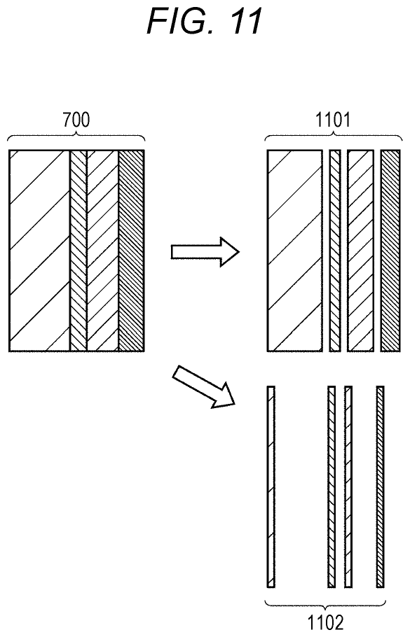

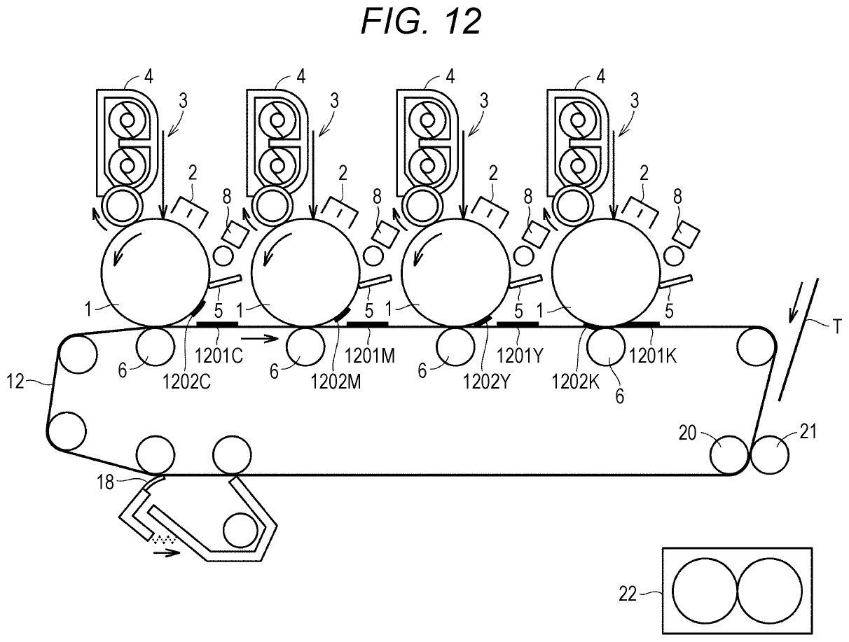

FIG. 11 is a diagram illustrating a fifth example of the waste toner pattern. In the example of FIG. 11, the controller 50 controls the imaging units 10 to transfer a part 1101 of the waste toner pattern 700 illustrated in FIG. 7 to the intermediate transfer belt 12, and leave a remaining part 1102 of the waste toner pattern 700 on the photoreceptor 1.

The belt cleaner 18 removes the part 1101 of the waste toner pattern 700 transferred to the intermediate transfer belt 12. On the other hand, the cleaner 5 removes the part 1102 of the waste toner pattern 700 remaining on the photoreceptor 1 without being transferred to the intermediate transfer belt 12. Note that, the part 1102 of the waste toner pattern remaining on the photoreceptor 1 may be a head portion or a tail portion of the waste toner pattern formed on the photoreceptor 1. Note that, the controller 50 causes a belt charger (not illustrated) to charge the intermediate transfer belt 12 to the same polarity as that during normal printing, thereby transferring waste toners 1201C, 1201M, 1201Y, and 1201K to the intermediate transfer belt 12. In addition, the controller 50 causes the belt charger to charge the intermediate transfer belt 12 to a polarity opposite to that during normal printing, thereby leaving waste toners 1202C, 1202M, 1202Y, and 1202K on the photoreceptors 1.

In one aspect, the controller 50 may set the amounts of toners of the waste toners 1202C, 1202M, 1202Y, and 1202K remaining on the photoreceptors 1 within the minimum coverage rate. In that case, the amounts of toners of the waste toners 1202C, 1202M, 1202Y, and 1202K remaining on the photoreceptors 1 are smaller than the amounts of toners of the waste toners 1201C, 1201M, 1201Y, and 1201K transferred to the intermediate transfer belt 12, respectively.

FIG. 12 is a diagram illustrating an example of a state of separation of the waste toner pattern in the fifth example of the waste toner pattern. The waste toners 1201C, 1201M, 1201Y, and 1201K are included in the part 1101 of the waste toner pattern 700. The waste toners 1202C, 1202M, 1202Y, and 1202K are included in the part 1102 of the waste toner pattern 700. The belt cleaner 18 removes the waste toners 1201C, 1201M, 1201Y, and 1201K. The cleaners 5 corresponding to the toners of the respective colors removes the waste toners 1202C, 1202M, 1202Y, and 1202K.

As described above, the controller 50 causes the imaging units 10 to form the waste toner pattern exemplified in FIGS. 11 and 12, thereby distributing the load to the cleaners 5 and the belt cleaner 18, and reducing the load on the cleaners 5 and the belt cleaner 18. As a result, the cleaning failure in the belt cleaner 18 is suppressed.

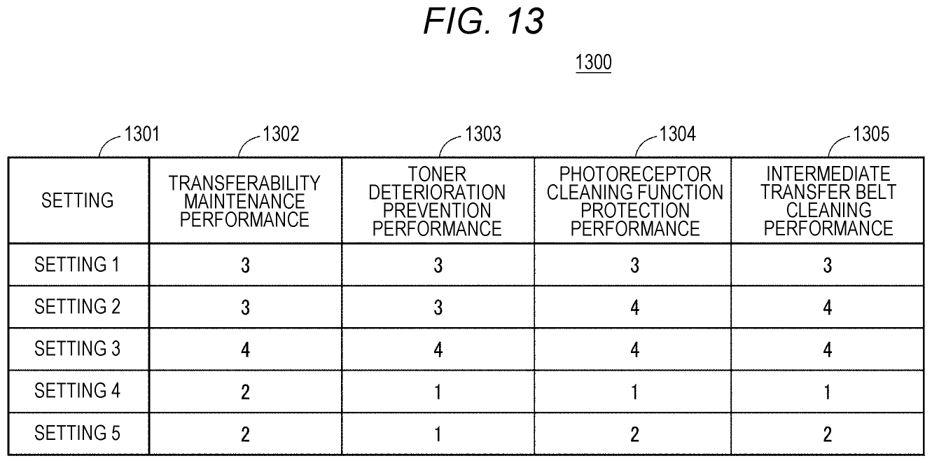

FIG. 13 is a diagram illustrating an example of a comparison between a waste toner removing method according to the present embodiment and a conventional waste toner removing method.

A comparison table 1300 includes comparison items of the waste toner removing methods. More specifically, the comparison table 1300 includes a setting 1301, transferability maintenance performance 1302, toner deterioration prevention performance 1303, photoreceptor cleaning function protection performance 1304, and intermediate transfer belt cleaning performance 1305. The evaluation of each item is represented by “1 to 4”, and the higher the number, the higher the performance.

Each evaluation item of a setting 1 indicates the evaluation of a control method exemplified by the waste toner pattern of FIG. 7. Each evaluation item of a setting 2 indicates the evaluation of a control method exemplified by the waste toner pattern of FIG. 11. Each evaluation item of a setting 3 indicates the evaluation of a control method exemplified by the waste toner patterns of FIGS. 8 to 10.

Each evaluation item of a setting 4 indicates the evaluation of a conventional toner discard control method. In the conventional toner discard control method, it is assumed that the toner of each color is discarded at the same ratio, and that all the waste toner is removed by the belt cleaner 18. Each evaluation item of a setting 5 indicates the evaluation in a case where the control method of the setting 4 is combined with a method of distributing the waste toner on the intermediate transfer belt 12 and the photoreceptor 1 exemplified in FIG. 11. Effects of the settings 1 to 3 according to the present embodiment will be described mainly in comparison with the conventional setting 4.

The transferability maintenance performance 1302 indicates transferability maintenance performance of the toner image with respect to the medium 40 of the intermediate transfer belt 12. The toner deterioration prevention performance 1303 indicates performance of preventing deterioration of the toner stored in the developer 4. The photoreceptor cleaning function protection performance 1304 indicates performance of maintaining cleaning performance for the photoreceptor 1 or performance of suppressing damage of the cleaner 5. The intermediate transfer belt cleaning performance 1305 indicates performance of removing the waste toner by the intermediate transfer belt 12.

When the setting 1 is compared with the setting 4, the setting 1 outperforms the setting 4 in all items. These performance improvements are due to the fact that the ratio of the discarded toner of each color is based on the degree of deterioration of the toner in the developer 4, and that a certain interval is provided for the waste toner patterns, in the control method of the setting 1.

In the control method of the setting 1, since the ratio of the discarded toner of each color is based on the degree of deterioration of the toner in the developer 4, the toner with more severe deterioration is discarded in a larger amount, and the toner deterioration prevention performance 1303 is increased. As a result, the degrees of deterioration of all the toners are kept uniform, and the transferability maintenance performance 1302 is increased. In addition, the total distance of idle rotation of the photoreceptors 1 of the respective colors is reduced, and the photoreceptor cleaning function protection performance 1304 is also increased.

Further, in the control method of the setting 1, since the certain interval is provided for the waste toner patterns, the belt cleaner 18 is unlikely to cause the cleaning failure and can remove the toner without difficulty. As a result, the intermediate transfer belt cleaning performance 1305 is improved.

Next, when the setting 2 is compared with the setting 4, the setting 2 outperforms the setting 4 in all items, and can achieve very high performance improvements, in the photoreceptor cleaning function protection performance 1304 and the intermediate transfer belt cleaning performance 1305. These performance improvements are due to the fact that the waste toner is subjected to distributed removal by the cleaners 5 and the belt cleaner 18 in the control method of the setting 2. In the control method of the setting 1, since the cleaners 5 and the belt cleaner 18 perform the removal of the waste toner in a distributed manner, the photoreceptor cleaning function protection performance 1304 and the intermediate transfer belt cleaning performance 1305 can be significantly improved. Further, when the setting 2 is compared with the setting 5, the setting 2 outperforms the setting 5 in which only the distributed removal of the waste toner by the cleaners 5 and the belt cleaner 18 is performed, in all types of performance.

Next, when the setting 3 is compared with the setting 4, it can be seen that the setting 3 can achieve a very high performance improvement in all items, with respect to the setting 4. In the control method of the setting 3, in addition to the control method of the setting 2, the toner is discarded by further using the minimum coverage rate as a unit for efficiently discarding the toner, and further performance improvement can be achieved in the transferability maintenance performance 1302 and the toner deterioration prevention performance 1303.

As described above, the image forming apparatus 100 determines the ratio of the waste toner on the basis of the degree of deterioration of the toner in the developer 4 and provides the certain interval for the waste toner patterns, thereby being able to achieve improvement of various types of performance as compared with the conventional toner discard control. Further, the image forming apparatus 100 can further improve various types of performance by combining the control using the distributed removal of the waste toner by the cleaners 5 and the belt cleaner 18 and the control using the minimum coverage rate.

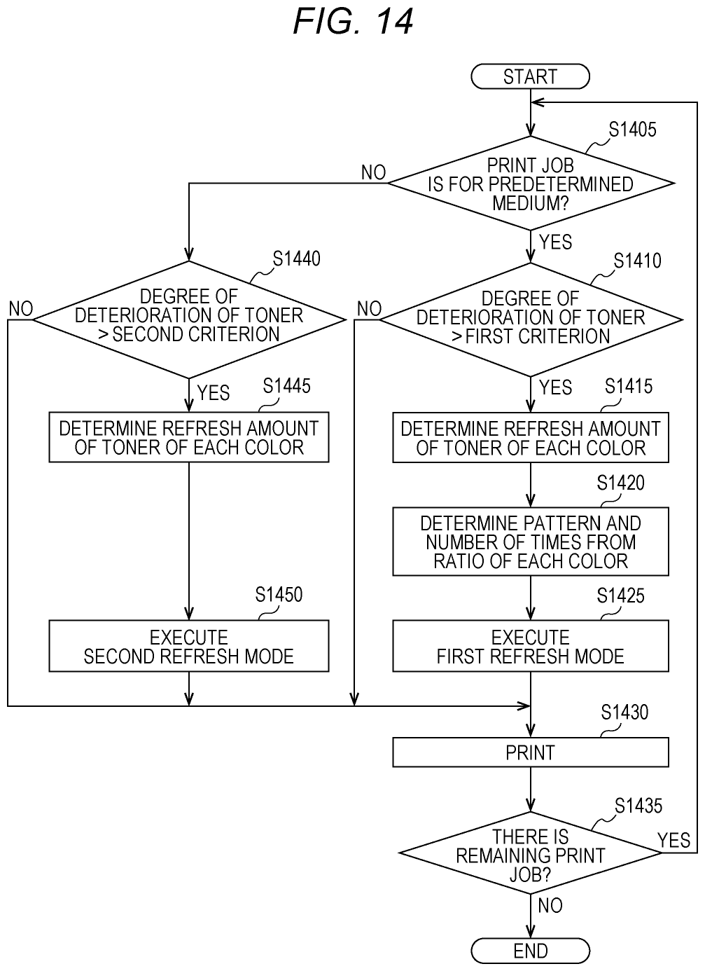

FIG. 14 is a diagram illustrating an example of the flow of the toner discard processing. In one aspect, the controller 50 may read a program for performing the processing in FIG. 14 from the storage unit 51 and execute the program. In another aspect, a part or all of the discard processing can be implemented as a combination of circuit elements configured to execute the processing.

In step S1405, the controller 50 determines whether or not an acquired print job is printing processing on a predetermined medium. Here, the predetermined medium is, for example, a special sheet or the like. The controller 50 can acquire the print job via the operation controller 301. If it is determined that the acquired print job is the printing processing on the predetermined medium (YES in step S1405), the controller 50 shifts the control to step S1410. If not (NO in step S1405), the controller 50 shifts the control to step S1440.

In step S1410, the controller 50 determines whether or not the degree of deterioration of the toner is greater than or equal to a first criterion on the basis of a criterion acquired from the storage unit 51. In one aspect, the first criterion may be the residence time of the toner in the developer 4. Other data may be used for the first criterion. If it is determined that the degree of deterioration of the toner is greater than or equal to the first criterion (YES in step S1410), the controller 50 shifts the control to step S1415. If not (NO in step S1410), the controller 50 shifts the control to step S1430.

In one aspect, the controller 50 may determine whether or not the degrees of deterioration of the toners of the respective colors are greater than or equal to the first criterion. In that case, the controller 50 may shift the control to step S1415 if the degree of deterioration of even one color is greater than or equal to the first criterion. Alternatively, the controller 50 may determine whether or not an average value of the degrees of deterioration of the toners of the respective colors is greater than or equal to the first criterion.

In step S1415, the controller 50 determines the refresh amount of the toner of each color. The refresh amount here is the amount of toner to be discarded. The controller 50 may determine the refresh amount of the toner of each color with reference to the discharge amount table 307.

In step S1420, the controller 50 determines the ratio of the toner of each color included in the waste toner pattern and the number of times of forming the waste toner pattern on the basis of the ratio of the refresh amount of the toner of each color. The controller 50 may determine the ratio of the toner of each color included in the waste toner pattern and the number of times of forming the waste toner pattern with reference to the discharge pattern setting table 308.

In step S1425, the controller 50 executes the toner discard processing in a first refresh mode. The first refresh mode is a toner discard processing mode using the first criterion. The controller 50 can discard the toner by any of the control methods exemplified in FIGS. 7 to 12.

In step S1430, the controller 50 controls each actuator 305 to execute the printing processing. The printing processing here refers to printing processing using a predetermined medium such as a special medium.

In step S1435, the controller 50 determines whether or not there is an unexecuted print job. If it is determined that there is an unexecuted print job (YES in step S1435), the controller 50 shifts the control to step S1405. If not (NO in step S1435), the controller 50 ends the processing.

In step S1440, the controller 50 determines whether or not the degree of deterioration of the toner is greater than or equal to a second criterion on the basis of the criterion acquired from the storage unit 51. The second criterion is a criterion lower than the first criterion. For example, while the first criterion is the residence time “100 hours” of the toner in the developer 4, the second criterion may be the residence time “200 hours” of the toner in the developer 4. If it is determined that the degree of deterioration of the toner is greater than or equal to the second criterion (YES in step S1440), the controller 50 shifts the control to step S1445. If not (NO in step S1440), the controller 50 shifts the control to step S1430.

In one aspect, the controller 50 may determine whether or not the degrees of deterioration of the toners of the respective colors are greater than or equal to the second criterion. In that case, the controller 50 may shift the control to step S1445 if the degree of deterioration of even one color is greater than or equal to the second criterion. Alternatively, the controller 50 may determine whether or not an average value of the degrees of deterioration of the toners of the respective colors is greater than or equal to the second criterion.

In step S1445, the controller 50 determines the refresh amount of the toner of each color. The refresh amount here is the amount of toner to be discarded. The controller 50 may determine the refresh amount of the toner of each color with reference to the discharge amount table 307. In addition, the controller 50 may set the same discard amount of the toner for each color.

In step S1450, the controller 50 executes the toner discard processing in a second refresh mode. The second refresh mode is toner discard processing using the second criterion. The controller 50 may discard a certain amount of the toner for all colors without setting a ratio for the discarded amount of the toner of each color. In addition, the controller 50 may discard the toner by any of the control methods exemplified in FIGS. 7 to 12. In that case, the controller 50 can execute processing corresponding to step S1420 after step S1445. In one aspect, the controller 50 does not have to perform the toner refresh for a print job not using the predetermined medium. In one aspect, the controller 50 may display information regarding a change in the degree of deterioration of the toner of each color on the monitor of the image forming apparatus 100 after the execution of the first refresh mode or the second refresh mode.

As described above, the controller 50 can maintain printing performance by discarding the toner by any of the control methods exemplified in FIGS. 7 to 12 by using the first criterion only when printing is performed on a medium that is easily affected by the deterioration of the toner. Further, when printing is performed on a plain sheet or the like, the controller 50 can efficiently use the toner by lowering the criterion for toner discard.

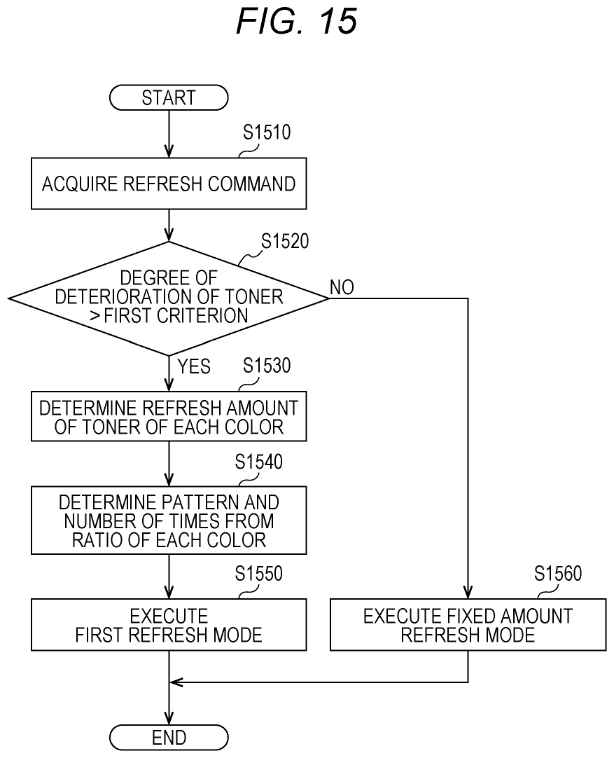

FIG. 15 is a diagram illustrating an example of a flow of toner discard processing by manual operation. In one aspect, the controller 50 may read a program for performing the processing in FIG. 15 from the storage unit 51 and execute the program. In another aspect, a part or all of the discard processing can be implemented as a combination of circuit elements configured to execute the processing. In the processing of FIG. 14, the controller 50 performs toner discard on the basis of the degree of deterioration of the toner, whereas in the processing of FIG. 15, the controller 50 forcibly discards the toner on the basis of a user command.

In step S1510, the communication unit 302 or the input/output unit 304 acquires a command for toner refresh processing from the user. The communication unit 302 can acquire the command for toner refresh processing from a user terminal via a network. The input/output unit 304 can acquire the command for toner refresh processing from the user via an input of the button or the touch panel.

In step S1520, the controller 50 determines whether or not the degree of deterioration of the toner is greater than or equal to the first criterion on the basis of the criterion acquired from the storage unit 51. If it is determined that the degree of deterioration of the toner is greater than or equal to the first criterion (YES in step S1520), the controller 50 shifts the control to step S1530. If not (NO in step S1520), the controller 50 shifts the control to step S1560.

In step S1530, the controller 50 determines the refresh amount of the toner of each color. The refresh amount here is the amount of toner to be discarded. The controller 50 may determine the refresh amount of the toner of each color with reference to the discharge amount table 307.

In step S1540, the controller 50 determines the ratio of the toner of each color included in the waste toner pattern and the number of times of forming the waste toner pattern on the basis of the ratio of the refresh amount of the toner of each color. The controller 50 may determine the ratio of the toner of each color included in the waste toner pattern and the number of times of forming the waste toner pattern with reference to the discharge pattern setting table 308.

In step S1550, the controller 50 executes the toner discard processing in the first refresh mode. The first refresh mode is the toner discard processing mode using the first criterion. The controller 50 can discard the toner by any of the control methods exemplified in FIGS. 7 to 12.

In step S1560, the controller 50 executes the toner discarding processing in a fixed amount refresh mode. The fixed amount refresh mode is a mode in which the toner of each color is discarded at a certain ratio.

As described above, the image forming apparatus 100 according to the present embodiment determines the ratio of the waste toner on the basis of the degree of deterioration of the toner in the developer 4, and provides the certain interval for the waste toner patterns. By enabling the belt cleaner 18 to remove the waste toner without difficulty, various types of performance can be improved as compared with the conventional toner discard control. Further, the image forming apparatus 100 can further improve various types of performance by combining the control using the distributed removal of the waste toner by the cleaners 5 and the belt cleaner 18 and the control using the minimum coverage rate.

Further, the image forming apparatus 100 can maintain the printing performance by discarding the toner by any of the control methods exemplified in FIGS. 7 to 12 only when printing is performed on a medium that is easily affected by the deterioration of the toner, and can also use the toner efficiently by lowering the criterion for discarding the toner when printing is performed on a plain sheet or the like.

Although embodiments of the present invention have been described and illustrated in detail, the disclosed embodiments are made for purposes of illustration and example only and not limitation. The scope of the present invention should be interpreted by terms of the appended claims, and it is intended that meanings equivalent to the claims and all modifications within the scope are included.

What is claimed is:

1. An image forming apparatus comprising:
a plurality of imaging units that forms toner images of respective colors;
an intermediate transfer belt that transfers the toner images;
a belt cleaner that cleans the intermediate transfer belt; and
a controller that controls the image forming apparatus, wherein
the controller
determines a degree of deterioration based on a residence time within the imaging units, for each of toners of the respective colors,
determines a discharge amount of each of the toners of the respective colors on a basis of the degree of deterioration,
controls the plurality of imaging units in accordance with a ratio of the discharge amount of each of the toners of the respective colors, and causes a waste toner pattern in which the toners of the respective colors are continuously arranged to be formed a plurality of times, while providing a predetermined interval, on the intermediate transfer belt, and
the belt cleaner cleans the waste toner pattern transferred the plurality of times to the intermediate transfer belt.

2. The image forming apparatus according to claim 1, wherein causing the waste toner pattern to be formed the plurality of times includes causing the waste toner pattern to be formed such that a length of the waste toner pattern in a traveling direction of the intermediate transfer belt is a predetermined length.

3. The image forming apparatus according to claim 1, wherein determining the discharge amount includes increasing a discharge amount of a toner of a color whose discharge amount is less than a predetermined coverage rate on a basis of a fact that any of the discharge amounts of the toners of the respective colors is less than a predetermined coverage rate.

4. The image forming apparatus according to claim 1, wherein forming the waste toner pattern includes adding a toner pattern of a color whose discharge amount is less than a predetermined coverage rate, to the waste toner pattern, on a basis of a fact that any of the discharge amounts of the toners of the respective colors is less than a predetermined coverage rate.

5. The image forming apparatus according to claim 4, wherein adding the toner pattern of the color whose discharge amount is less than the coverage rate includes forming the toner pattern of the color whose discharge amount is less than the coverage rate within the predetermined interval of the intermediate transfer belt.

6. The image forming apparatus according to claim 4, wherein adding the toner pattern of the color whose discharge amount is less than the coverage rate includes forming the toner pattern of the color whose discharge amount is less than the coverage rate continuously after forming the waste toner pattern.

7. The image forming apparatus according to claim 4, wherein adding the toner pattern of the color whose discharge amount is less than the coverage rate includes shortening the predetermined interval by a length of the added toner on a basis of forming the toner pattern of the color whose discharge amount is less than the coverage rate.

8. The image forming apparatus according to claim 1, wherein forming the waste toner pattern includes forming the waste toner pattern on the intermediate transfer belt on a basis of performing printing processing by using a predetermined medium.

9. The image forming apparatus according to claim 1, further comprising
a monitor, wherein
the controller displays information regarding a change in the degree of deterioration of each of the toners of the respective colors, on the monitor, after cleaning the waste toner pattern.

10. An image forming apparatus comprising:
a plurality of imaging units that forms toner images of respective colors;
an intermediate transfer belt that transfers the toner images;
a belt cleaner that cleans the intermediate transfer belt; and
a controller that controls the image forming apparatus, wherein
each of the plurality of imaging units includes:
a photoreceptor that forms a toner image;
a developer that supplies toner to the photoreceptor; and
a photoreceptor cleaner that cleans a surface of the photoreceptor,
the controller
causes the developer to form a waste toner pattern on the surface of the photoreceptor, and
causes a part of the waste toner pattern to be transferred from the photoreceptor to the intermediate transfer belt,
the belt cleaner cleans the part of the waste toner pattern transferred to the intermediate transfer belt, and
the photoreceptor cleaner cleans rest of the waste toner pattern remaining on the photoreceptor.

11. The image forming apparatus according to claim 10, wherein
the controller
determines a degree of deterioration based on a residence time within the imaging units, for each of toners of the respective colors,
determines a discharge amount of each of the toners of the respective colors on a basis of the degree of deterioration, and
causing the waste toner pattern to be formed includes causing the waste toner pattern to be formed on each of the photoreceptors in accordance with a ratio of a discharge amount of each of the toners of the respective colors.

12. The image forming apparatus according to claim 10, wherein an amount of toner included in a part of the waste toner pattern of each color transferred to the intermediate transfer belt is larger than an amount of toner included in the rest of the waste toner pattern remaining on the photoreceptor of the corresponding color.

13. The image forming apparatus according to claim 10, further comprising
a belt charger that charges the intermediate transfer belt, wherein
the controller
causes the belt charger to charge the intermediate transfer belt to a polarity identical to a polarity at a normal time, in a first period, and
causes the belt charger to charge the intermediate transfer belt to a polarity opposite to the polarity at the normal time, in a second period.

14. The image forming apparatus according to claim 10, wherein when transferring the waste toner pattern formed on the photoreceptor of each of the toners of the respective colors to the intermediate transfer belt, the belt charger charges the intermediate transfer belt to a polarity opposite to a polarity at a normal time, and then charges the intermediate transfer belt to a polarity identical to the polarity at the normal time.

15. The image forming apparatus according to claim 10, wherein when transferring the waste toner pattern formed on the photoreceptor of each of the toners of the respective colors to the intermediate transfer belt, the belt charger charges the intermediate transfer belt to a polarity identical to a polarity at a normal time, and then charges the intermediate transfer belt to a polarity opposite to the polarity at the normal time.

16. The image forming apparatus according to claim 10, wherein the controller adjusts an amount of toner included in the rest of the waste toner pattern remaining on the photoreceptor to be less than or equal to a predetermined coverage rate.

17. A control method comprising:
determining a degree of deterioration based on a residence time within a plurality of imaging units, for each of toners of respective colors;
determining a discharge amount of each of the toners of the respective colors on a basis of the degree of deterioration;
controlling the plurality of imaging units in accordance with a ratio of the discharge amount of each of the toners of the respective colors, and causing a waste toner pattern in which the toners of the respective colors are continuously arranged to be formed a plurality of times, while providing a predetermined interval, on an intermediate transfer belt, and
cleaning the waste toner pattern transferred the plurality of times to the intermediate transfer belt.

18. The control method according to claim 17, wherein causing the waste toner pattern to be formed the plurality of times includes causing the waste toner pattern to be formed such that a length of the waste toner pattern in a traveling direction of the intermediate transfer belt is a predetermined length.

19. The control method according to claim 17, wherein determining the discharge amount includes increasing a discharge amount of a toner of a color whose discharge amount is less than a predetermined coverage rate on a basis of a fact that any of the discharge amounts of the toners of the respective colors is less than a predetermined coverage rate.

20. The control method according to claim 17, wherein forming the waste toner pattern includes adding a toner pattern of a color whose discharge amount is less than a predetermined coverage rate, to the waste toner pattern, on a basis of a fact that any of the discharge amounts of the toners of the respective colors is less than a predetermined coverage rate.
